(19) United States
(12) Patent Application Publication
(10) Pub. No.: US 2008/0189367 A1
(43) Pub. Date: Aug. 7, 2008

(54) User-to-user communication method, program, and apparatus

(75) Inventor: Koji Okumura, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/000,808

(22) Filed: Dec. 18, 2007

(30) Foreign Application Priority Data
Feb. 1, 2007 (JP) 2007-022838

(51) Int. Cl. G06F 15/16

(52) U.S. Cl. 709/204

(57) ABSTRACT

A user-to-user communication system allows users to chat with each other by sending messages via a computer. The computer also includes a chatbot with which the users can chat; that chatbot generates response messages automatically. The computer keeps a history of messages sent by the users, infers users' interests from the content of the messages they send, matches users with similar interests, and presents the matched users as suitable chat partners. In inferring users' interests, the computer also considers message sent to the chatbot, so that a user can be matched with suitable partners even before the user has accumulated an extensive history of communication with other users.

### BACKGROUND OF THE INVENTION

1. Subject of the Invention

The present invention relates to technology for facilitating social communication by exchanges of text messages over a network, and in particular to technology for matching communication partners.

2. Description of the Related Art

Communication networks such as the Internet are used not just for transmitting information but also for social interaction between users. A typical form of social communication on the Internet is the so-called ‘chat’.

In an Internet chat, complete strangers can communicate with each other. A resulting problem is that selecting chat partners with the same interests from a list of unfamiliar chat participants is a matter of chance.

A solution to this problem is proposed in Japanese Patent Application Publication No. 2003-108507, the translated English abstract of which reads as follows:

‘A contact-degree base user selecting part 34 specifies a user Bi (i is an integer) familiar with a certain user A on the basis of chats between the users. A similarity calculating part 38 specifies a user Bij (j is an integer) having high similarity in personality to the user Bi, and the degree of the similarity Bij. A randomizing part 44 imparts randomizing processing from a viewpoint of amusement performance to the standing of the user Bij having the high similarity. A result presenting part 46 introduces the finally remaining user to the user A as a best match user.’

This solution is premised on there having been enough chats between users in the system to generate sufficient data for calculating the users' similarity.

A user, however, encounters the greatest difficulty in selecting chat partners when participating in a chat for the first time, and since at this point the user has no chat history at all, the method described above cannot be used to introduce the user to suitable chat partners.

### SUMMARY OF THE INVENTION

An object of the present invention is to provide a method of matching users by learning their preferred subjects of conversation and calculating the similarity of their interests even before the users have accumulated a history of chats with other users.

In a system in which users exchange messages entered at user terminals over a network, the invention provides a computing apparatus, connected to the network, that has an automatic response unit that generates automatic response messages in response to users' messages.

The computing apparatus also has a storage unit in which it stores at least the messages sent by the user to the automatic response unit in a message history table. Messages exchanged between users may also be stored in the message history table. An identification unit identifies users with matching interests on the basis of the message history table, taking the messages sent to the automatic response unit into account. Information is then presented to the users with matching interests so that they can exchanges message with each other.

Since the message history table includes messages sent from a user to the automatic response unit, the user's interests can be identified automatically on the basis of these messages, and the user can be introduced to suitable message exchange partners even before the user has accumulated an adequate history of message exchange with other users.

### BRIEF DESCRIPTION OF THE DRAWINGS

In the attached drawings:

FIG. 1 is a functional block diagram illustrating a user-to-user communication apparatus according to a first embodiment and its connection to a pair of terminals;

FIG. 2 shows the structure of the message history table in the first embodiment and shows exemplary data;

FIG. 3 shows the structure of the user interest level table in the first embodiment and shows exemplary data;

FIG. 4 illustrates a message sending sequence between the user terminals;

FIG. 5 illustrates a message sending sequence between a user terminal and the chatbot unit;

FIG. 6 illustrates a user matching sequence;

FIG. 7 is a flowchart illustrating the operation of the chatbot unit;

FIG. 8 shows the structure of the message history table according to a second embodiment and shows exemplary data;

FIG. 9 shows the structure of a key word relation table which is referred to by the user interest level calculation unit to obtain user interest levels according to a third embodiment, and shows exemplary data;

FIG. 10 is a table illustrating an exemplary conversation between a user and the chatbot unit;

FIG. 11 shows the structure of the message history table according to a fifth embodiment, and shows exemplary data;

FIG. 12 is a flowchart illustrating the operation of the chatbot unit in a seventh embodiment; and

FIG. 13 is a flowchart illustrating the operation of the chatbot unit in an eighth embodiment.

### DETAILED DESCRIPTION OF THE INVENTION

Embodiments of the invention will now be described with reference to the attached drawings, in which like elements are indicated by like reference characters.

### First Embodiment

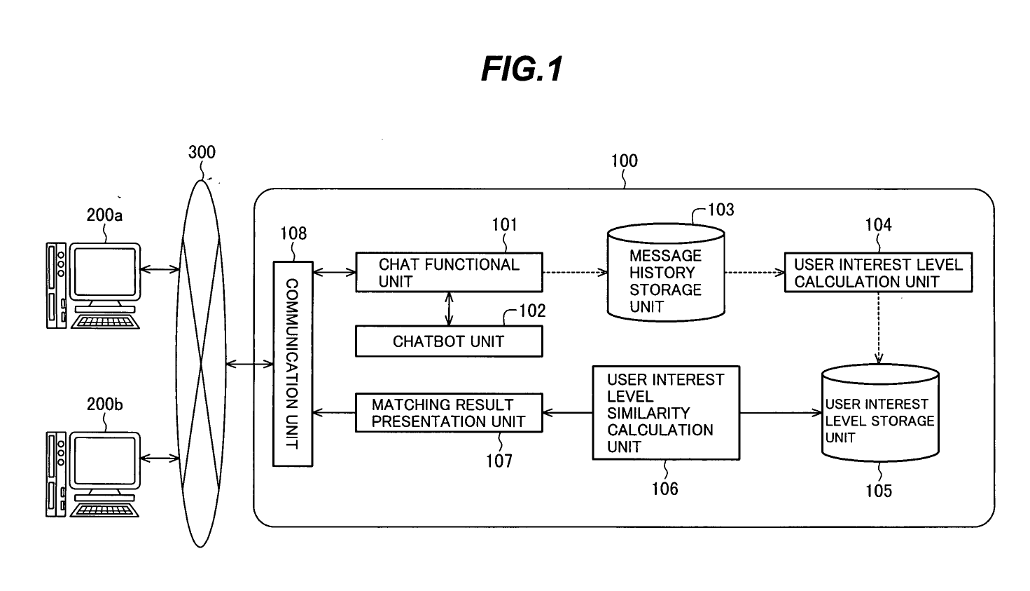

Referring to FIG. 1, in the first embodiment, a user-to-user communication apparatus 100 is connected to user terminals 200a, 200b through a network 300.

When a user chats with another user, the user operates user terminal 200a or user terminal 200b to connect to the user-to-user communication apparatus 100 through the network 300. User terminal 200a or 200b sends a message input by the user to the user-to-user communication apparatus 100 or receives a message sent by the user-to-user communication apparatus 100. The user-to-user communication apparatus 100 provides a chat room function by mediating the messages sent by user terminal 200a or 200b.

The user-to-user communication apparatus 100 comprises a chat functional unit 101, an automatic response unit or chatbot (chat robot) unit 102, a message history storage unit 103, a user interest level calculation unit 104, a user interest level storage unit 105, a user interest level similarity calculation unit 106, a matching result presentation unit 107, and a communication unit 108.

The chat functional unit 101 performs general chat functions, such as exchanging messages between users, registering users, and setting up and managing chat rooms. When the chat functional unit 101 receives a message from a user, the chatbot unit 102 outputs an automatic response message in accordance with a procedure which will be described later, and the output message is sent to the user through the chat functional unit 101 as if the user were chatting with the chatbot unit 102.

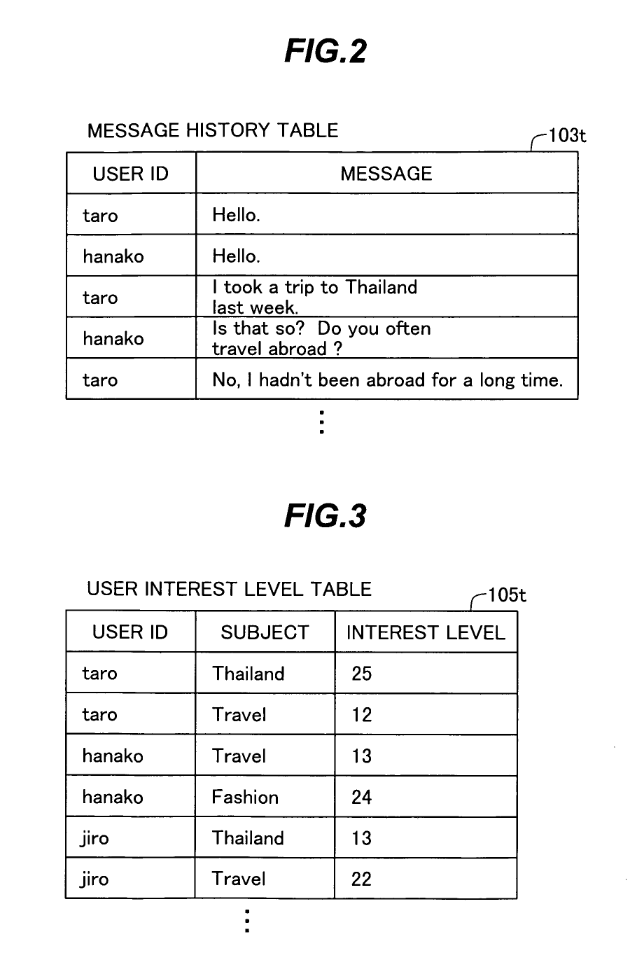

The message history storage unit 103 has a message history table 103t, which will be described later with reference to FIG. 2. The message history table 103t stores the messages the users exchange through the user-to-user communication apparatus 100.

The user interest level calculation unit 104 calculates a user's interest level (degree of interest) in each subject in the user's range of interests, by using the message history stored in the message history storage unit 103.

The user interest level storage unit 105 has a user interest level table 105t, which will be described later with reference to FIG. 3. The user interest level table 105t stores results of calculations by the user interest level calculation unit 104.

The user interest level similarity calculation unit 106, which functions as the identification unit, calculates degrees of similarity between users' interests by using the information stored in the user interest level table 105t.

The matching result presentation unit 107 identifies (matches) users interested in the same subjects to the same or similar degrees, on the basis of the results of the calculations performed by the user interest level similarity calculation unit 106, and presents the resulting matches.

The communication unit 108 interconnects the user-to-user communication apparatus 100 and the network 300 and communicates with user terminals 200a and 200b.

The chat functional unit 101, chatbot unit 102, user interest level calculation unit 104, user interest level similarity calculation unit 106, and matching result presentation unit 107 may be configured by hardware circuits implementing the corresponding functions, or as software executed by a general-purpose computing device such as the central processing unit (CPU) of a computer. The message history storage unit 103 and user interest level storage unit 105 may be configured in various types of storage devices, including random access memory (RAM), various other types of volatile or nonvolatile semiconductor memory, or a hard disk drive (HDD). The message history storage unit 103 and user interest level storage unit 105 may be configured in the same storage unit. The communication unit 108 may be a network interface such as a local area network (LAN) interface or a network card. The user terminals 200a, 200b may be any type of terminals that can communicate with the user-to-user communication apparatus 100 through the network 300, such as personal computers or mobile telephone sets.

FIG. 2 shows the structure of the message history table 103t and exemplary data. The message history table 103t has a ‘User ID’ column and a ‘Message’ column. Stored in the ‘User ID’ column are the identifiers (IDs) of users who communicate through the user-to-user communication apparatus 100. Stored in the ‘Message’ column are the messages (text) sent by the users identified by the values in the ‘User ID’ column. Messages may be stored in order of date and time of sending, for example. This table includes a history of the messages sent by each user.

FIG. 3 shows the structure of the user interest level table 105t and exemplary data. The user interest level table 105t has a ‘User ID’ column, a ‘Subject’ column, and an ‘Interest Level’ column. Stored in the ‘User ID’ column are the IDs of users who communicate through the user-to-user communication apparatus 100. Stored in the ‘Subject’ column are the names of the apparent subjects of interest to the user identified by the value in the ‘User ID’ column. Stored in the ‘Interest Level’ column are numerical values expressing the level of interest of the user identified in the ‘User ID’ column in the subject listed in the ‘Subject’ column. A higher numerical value in the ‘Interest Level’ column represents a higher level of interest.

Prior to the description of the user matching process in the first embodiment, an overall description will be given of the chat processing sequence carried out by the user-to-user communication apparatus 100. Chat systems in general may be constructed to have messages sent directly between user terminals, or to have messages sent through a server. The following description assumes that the system routes messages through a server, more specifically through the user-to-user communication apparatus 100.

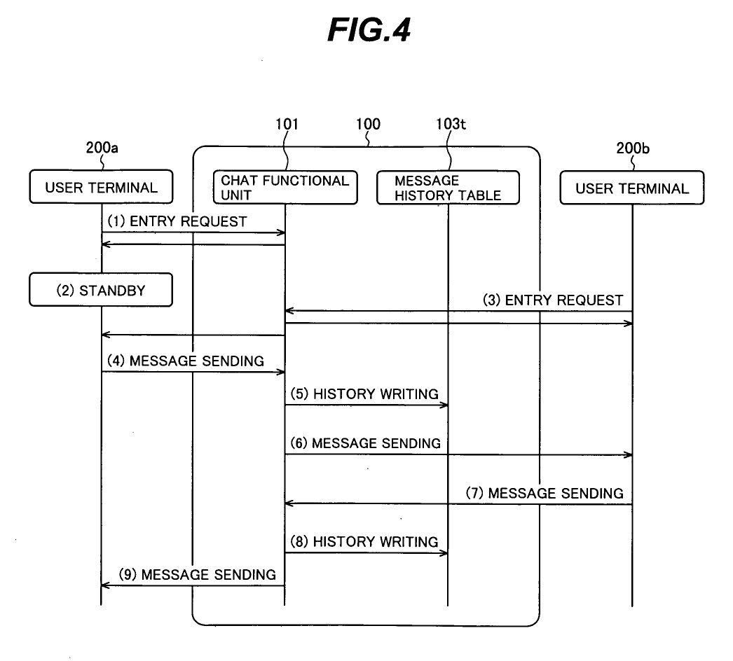

FIG. 4 illustrates a message sending sequence between user terminals 200a and 200b. The sequence includes the following steps.

(1) Entry request: The user of user terminal 200a operates the terminal to submit a request to enter a chat room maintained by the chat functional unit 101. User terminal 200a sends a packet, including the user's ID and the request to enter the chat room, to the user-to-user communication apparatus 100. If a user authentication process such as a log-in process is necessary, the packet may also include authentication information such as a password. The chat functional unit 101 receives the entry-requesting packet, authenticates the user if necessary, and reports the results to user terminal 200a.

(2) Standby: User terminal 200a waits until another user terminal (user terminal 200b in this case) enters the same chat room.

(3) Entry request: The user of user terminal 200b operates the terminal to submit a request to enter the chat room. User terminal 200b sends a packet including the request to enter the chat room to the user-to-user communication apparatus 100. The user authentication process is performed in the same way as in step (1). The fact that the user of user terminal 200b has entered the chat room is reported to user terminal 200a.

(4) Message sending: The user of user terminal 200a learns in step (3) that the user of user terminal 200b has entered the chat room and operates the terminal to send a message to the user of user terminal 200b. User terminal 200a sends a packet including the message to the user-to-user communication apparatus 100.

(5) History writing: The chat functional unit 101 receives the message packet sent by user terminal 200a and saves the message included in the packet in the message history table 103t. The user ID and the message text are stored in combination in the table. The chat functional unit 101 thus also functions as a history keeping unit.

(6) Message sending: The chat functional unit 101 sends the message packet received in step (5) to user terminal 200b.

(7) Message sending, (8) History writing, and (9) Message sending: User terminal 200b receives the message packet sent by the chat functional unit 101 and displays the message included in the packet on a display screen. The user of user terminal 200b notices the message from user terminal 200a and submits a reply message. The subsequent steps (7)-(9) are the same as steps (4)-(6) with the roles of user terminals 200a and 200b interchanged.

By the processing sequence described above, the users of user terminals 200a and 200b can chat by sending messages via the user-to-user communication apparatus 100.

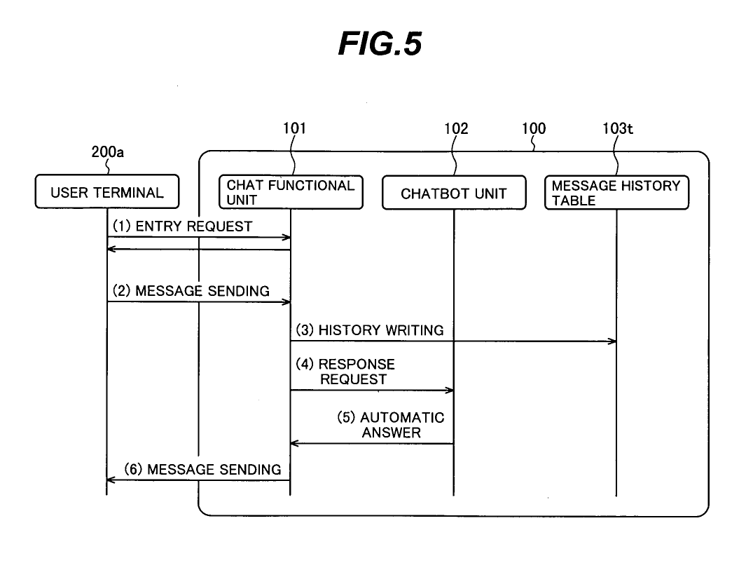

FIG. 5 illustrates a message sending sequence between user terminal 200a and the chatbot unit 102. This sequence includes the following steps:

(1) Entry request: This step is the same as step (1) in FIG. 4, except that when the chat functional unit 101 responds to the entry request, it indicates that the chatbot unit 102 is available as a chat partner.

(2) Message sending: The user of user terminal 200a operates the terminal to send a message to the chatbot unit 102. User terminal 200a sends a packet including the message to the user-to-user communication apparatus 100.

(3) History writing: This step is the same as step (5) in FIG. 4.

(4) Response request: The chat functional unit 101 passes the message from user terminal 200a to the chatbot unit 102, and asks the chatbot unit 102 to output a response message.

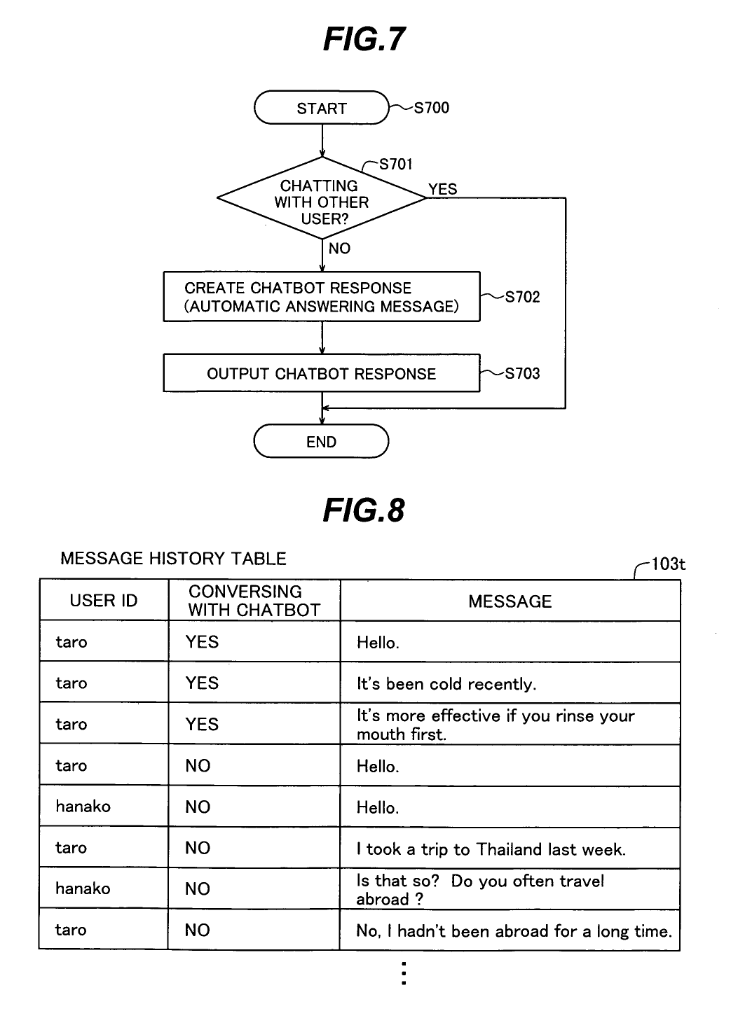

(5) Automatic answer: The chatbot unit 102 generates an automatic response message responding to the message sent from user terminal 200a and outputs the automatic response message to the chat functional unit 101. The method of generating the automatic response message will be described later with reference to FIG. 7.

(6) Message sending: The chat functional unit 101 sends user terminal 200a a packet including the message received in step (5).

The processing sequence described above enables the user of user terminal 200a to communicate with the chatbot unit 102 even if the user is alone in the chat room. In communication between the user and the chatbot unit 102, the messages sent from the user are stored in the message history table 103t. A user participating in a chat for the first time can accordingly inform the user-to-user communication apparatus 100 of his or her interests by chatting with the chatbot unit 102, after which the user can be matched appropriately with other users.

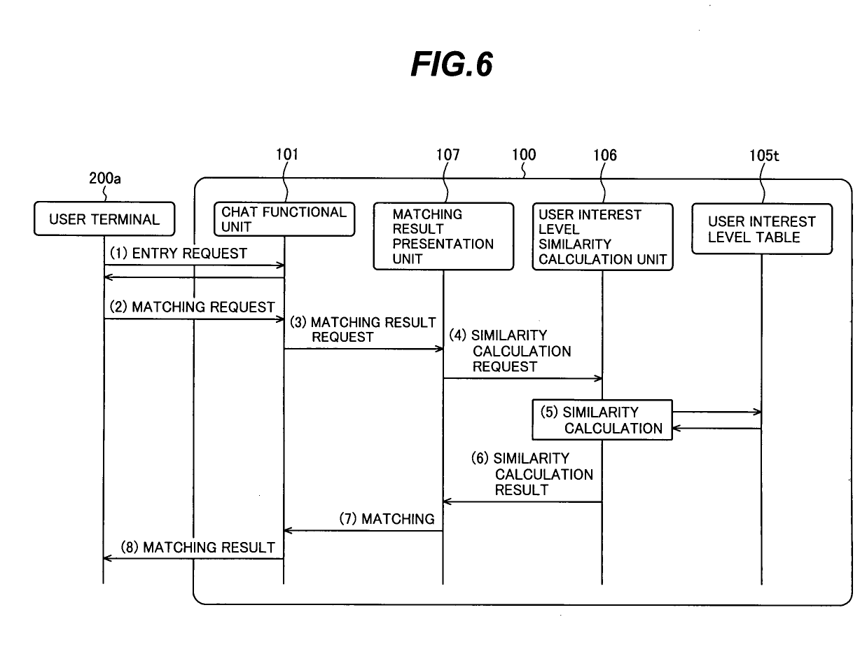

FIG. 6 illustrates a user matching sequence. This sequence has the following steps:

(1) Entry request: This step is the same as step (1) in FIG. 4.

(2) Matching request: The user of user terminal 200a operates the terminal to submit a request to be matched with a user having the same or similar interests (a matching request). User terminal 200a sends a packet including the matching request to the user-to-user communication apparatus 100.

(3) Matching result request: The chat functional unit 101 receives the matching request packet sent from user terminal 200a and asks the matching result presentation unit 107 to present matching results, giving the ID of the requesting user.

(4) Similarity calculation request: The matching result presentation unit 107 asks the user interest level similarity calculation unit 106 to calculate the degree of similarity between the interests of the requesting user and the interests of other users.

(5) Similarity calculation: The user interest level similarity calculation unit 106 reads users' interests and interest levels from the user interest level table 105t and calculates the degrees of similarity between the interests of the requesting user and the interests of the other users. The calculation method will be described later. The user interest level table 105t is presumed to contain the accumulated data calculated by the user interest level calculation unit 104, as shown in FIG. 3.

(6) Similarity calculation results: The user interest level similarity calculation unit 106 returns the results of the calculation in step (5) to the matching result presentation unit 107.

(7) Matching: The matching result presentation unit 107 selects a matching user whose interests match the interests of the requesting user as indicated by the similarity calculation results received from the user interest level similarity calculation unit 106, and reports the matching user's ID to the chat functional unit 101. In this embodiment, the matching user is simply the user with the highest degree of similarity of interests, but the matching result presentation unit 107 may take other factors, such as age and number of past chats, into account as well.

(8) Matching result: The chat functional unit 101 sends user terminal 200a the matching result received from the matching result presentation unit 107 (the user ID of a user who would be a good match for the requesting user).

The processing sequence described above matches users having similar interests. Even users participating in a chat for the first time can obtain appropriate results from the matching process if they have accumulated a message history in conversation with the chatbot unit 102, as described with reference to FIG. 5.

A user may request matching without requesting entry to a chat room, in which case step (1) can be omitted and the matching request can be sent directly to the matching result presentation unit 107.

Instead of calculating degrees of similarity of interests in response to a matching request, the user interest level similarity calculation unit 106 may calculate degrees of similarity of interests in advance and store the results in an arbitrary storage unit, to save processing time later or for other reasons.

The general operation sequences of the user-to-user communication apparatus 100 have been described above. The operation of its constituent units will now be described in further detail.

FIG. 7 is a flowchart illustrating the operation of the chatbot unit 102. The steps in this operation will be described below.

Step S700: This procedure is initiated when the chatbot unit 102 is called on to operate, and is performed by the chatbot unit 102 as step (5) in FIG. 5.

Step S701: The chatbot unit 102 decides whether the user is chatting with another user. If the user is already chatting with another user, the processing ends. Otherwise, the processing proceeds to step S702. If the chatbot unit 102 is configured to operate only when a response request is made by the chat functional unit 101, the chatbot unit 102 can let the chat functional unit 101 make the decision in step S701. Otherwise, the chatbot unit 102 itself can make the decision in this step itself by observing, for example, the number of users in the chat room and their message traffic.

Step S702: The chatbot unit 102 generates a chatbot response (automatic response message).

Step S703: The chatbot unit 102 outputs the chatbot response to the chat functional unit 101.

A variety of algorithms employed by known chatbots or in current artificial intelligence research can be used to generate the chatbot response in step S702 from the message sent by the user. Older algorithms such as the Eliza algorithm presented by Joseph Weizenbaum in 1966 can also be used.

The messages the user sends in the conversation with the chatbot unit 102 are stored in the message history table 103t, as shown in FIG. 5. The response message generated by the chatbot unit 102 may also be stored in the same table.

The operation of the user interest level calculation unit 104 will now be described. The processing performed by the user interest level calculation unit 104 is started as an independent process, such as a batch process, operating independently of the chat functional unit 101 and chatbot unit 102 and message history storage unit 103 but making use of the message history table 103t.

For each user, the user interest level calculation unit 104 extracts key words from the messages sent by the user, stored in the message history table 103t. Key words can be extracted by morphologic analysis or various other methods. For Japanese messages, for example, key words can be extracted simply by extracting words written in katakana or kanji instead of hiragana. The user interest level calculation unit 104 then calculates the user's level of interest in a subject in accordance with the number of occurrences of key words pertaining to the subject in the user's messages, and stores the calculated interest level in the user interest level table 105t. For example, a user's level of interest in the subject of ‘fashion’ may be calculated from the number of occurrences of key words such as ‘fashion’, ‘clothes’, and so on. Relationships between key words and subjects may be stored in advance in a table of the type shown in FIG. 3 of the Publication (JP 2003-108507) cited earlier. The term ‘personality factor’ in this Publication corresponds to the term ‘subject’ as used herein.

For Japanese messages, simple normalization processing may be carried out on the entries in the ‘Subject’ column in FIG. 3, such as converting kanji to katakana and standardizing the katakana orthography.

The level of interest in a particular subject is calculated so as to increase as increasing numbers of key words pertaining to that subject appear in the messages. If a high numerical value in the ‘Interest Level’ column in FIG. 3 corresponds to a high level of interest, then the level of interest is calculated from a strictly increasing function f(n) of the number n of key word occurrences. Strictly increasing means that for any pair of integers n₁, n₂,

if n₁<n₂ then f(n₁)<f(n₂).

Next the operation of the user interest level similarity calculation unit 106 will be described. The user interest level similarity calculation unit 106 calculates degrees of similarity by using the degrees of user interest stored in the user interest level table 105t in order to find a user having interests similar to those of the requesting user. The users to be searched through here may be limited to users currently connected to the user-to-user communication apparatus 100.

A high degree of similarity in user interests means that two users have high levels of interest in the same subjects. If a high degree of similarity of interests between users A and B is expressed by a high numerical value, then the similarity value can be calculated by the equation (1) below:

$$Similarity = {\sum }_{C}^{all} s ( {f}_{A C} , {f}_{BC} ) \qquad ( 1 )$$

where s(f_{AC}, f_{BC}) is a function such that if f_{AC1}>f_{AC2} and f_{BC1}>f_{BC2}, then S(f_{AC1}, f_{BC1})>s(f_{AC2}, f_{BC2}), and the symbols have the following meanings:

all: total over all recorded subjects

f_{AC}: level of interest of user A in subject C

f_{BC}: level of interest of user B in subject C

f_{AC1}: level of interest of user A in subject C1

f_{BC1}: level of interest of user B in subject C1

f_{AC2}: level of interest of user A in subject C2

f_{BC2}: level of interest of user B in subject C2

The user-to-user communication apparatus 100 in the first embodiment can determine the interests of even first-time chat participants, provided they have accumulated a message history in conversations with the chatbot unit 102. Users who have conversed with the chatbot unit 102 can accordingly be matched with chat partners sharing common interests regardless of the extent of their previous history of chatting with other human users. In addition, since users can amuse themselves by chatting with the chatbot unit 102 when no appropriate chat partner is available, users will tend to remain in the chat room longer, consequently increasing their opportunities to chat with other users who enter the chat room.

### Second Embodiment

In the first embodiment, a user's interests and interest levels are calculated from the user's entire message history, treating messages sent to the chatbot unit 102 in the same way as messages sent to other human users. In the second embodiment, the user interest level calculation unit 104 distinguishes between these two types of messages.

FIG. 8 shows the structure of the message history table 103t according to the second embodiment and shows exemplary data. The structure shown in FIG. 8 differs from the structure shown in FIG. 2 in that a ‘Conversing with Chatbot’ column is added. The ‘Conversing with Chatbot’ column indicates whether each message was exchanged between users or between a user and the chatbot unit 102. A ‘Yes’ in this column indicates that the message was part of a conversation with the chatbot unit 102. The other columns are the same as in FIG. 2. As shown in FIG. 8, the message history table 103t stores both messages exchanged between users and messages exchanged with the chatbot unit 102.

The operation of the user interest level calculation unit 104 in the second embodiment will now be described. When the user interest level calculation unit 104 calculates user interest levels in accordance with the messages stored in the message history table 103t shown in FIG. 8, it assigns different weights to messages, depending on whether they are marked ‘Yes’ or ‘No’ in the ‘Conversing with Chatbot’ column. For example, the level of user interest in a key word can be calculated by the equation (2) below:

User interest level=f(nₐ)+f′(nᵤ) (2)

where the symbols have the following meanings:

nₐ: number of key word occurrences in conversations with the chatbot unit 102

nᵤ: number of key word occurrences in conversations with other users

In a conversation with the chatbot unit 102, the user takes the initiative, so that the user messages in the conversation are likely to include more content of interest to the user than found in messages exchanged with other users. Therefore, the functions in equation (2) above preferably satisfy the following relationship (3) for all positive integers n (n>0).

f(n)>f′(n) (3)

In other words, messages sent to the chatbot unit 102 are given greater weight than messages sent to other users.

The greater weights assigned to messages exchanged with the chatbot unit 102 in the second embodiment enable users' true interests and interest levels to be identified more rapidly than in the first embodiment. The effect of the second embodiment is especially large for new users, who tend to reveal their interests more quickly to the chatbot unit 102 than to other users.

### Third Embodiment

In the first and second embodiments, a user is assumed to be interested in a particular subject if a key word directly pertaining to that subject is extracted from the messages sent by the user, and the user's level of interest is calculated from the number of occurrences of directly related key words. In the third embodiment, the user's level of interest is calculated from the number of occurrences of indirectly related key words as well.

In the third embodiment, the user interest level calculation unit 104 calculates the level of user interest in a subject represented by a particular key word by using the equation (4) below:

User interest level=f(n+r₁·nᵣ₁+r₂·nᵣ₂+ . . . +rₓ·nᵣₓ) (4)

where the symbols have the following meanings:

n: number of occurrences of the particular key word

nᵣₓ: number of occurrences of the xth related key word

rₓ: degree of relatedness of the xth related key word (rₓ<1)

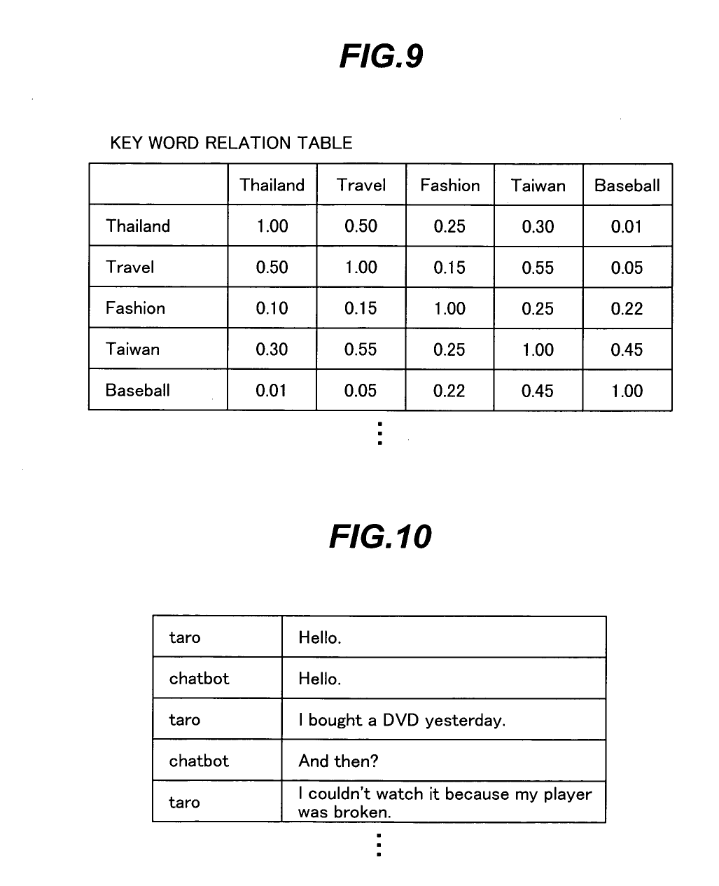

FIG. 9 shows the structure of a key word relation table, which is referenced by the user interest level calculation unit 104 when it calculates degrees of user interest according to the third embodiment, and shows exemplary data. This table can be stored in either the message history storage unit 103 or the user interest level storage unit 105. The key word relation table stores the value of the coefficients rₓ in the equation (4) given above. For the key words ‘Thailand’ and ‘travel’, for example, the degree of relatedness rₓ is ‘0.50’. When the user interest level calculation unit 104 obtains a user's interest level in the subject of ‘Thailand’, the unit uses the equation (4) and the key word relation table and includes other key words related to ‘Thailand’, such as ‘Travel’, ‘Fashion’, and ‘Taiwan’, in its calculation. Words having higher rₓ values count more in the calculation of user interest than words having lower rₓ values.

Since the user interest level calculation unit 104 now calculates user interest levels in a subject both from key words specifically pertaining to the subject and other key words related more indirectly, the third embodiment can find a wider range of users having similar interests. This makes it possible to match users who could not have been matched conventionally. If appropriate degrees of relatedness between key words are stored in the key word relation table illustrated in FIG. 9, the matched users will still discover that their interests overlap.

### Fourth Embodiment

Although providing a key word relation table with preset values as in the third embodiment enables the relatedness of different key words to be specified accurately, creating the table requires time and effort, which adds to system cost. In a fourth embodiment of the invention, the degree of relatedness between key words is determined automatically from the stream of messages.

FIG. 10 illustrates an exemplary conversation between a user and the chatbot unit 102. The chatbot unit 102 frequently outputs nonspecific messages that simply urge the user to continue the conversation. In the example in FIG. 10, ‘And then?’ is this type of nonspecific message. The user's reply to this message is presumably a continuation of the message the user sent immediately before. Therefore, the messages before and after ‘And then?’, and the key words appearing in these messages, can be presumed to have a considerable degree of relatedness. In the example shown in FIG. 10, ‘DVD’ and ‘player’ are presumed to be related.

The user interest level calculation unit 104 obtains degrees of relatedness between key words as described above and creates and maintains the key word relation table, then uses the relatedness values in the key word relation table as coefficients in the calculation of user interest levels.

The message history table 103t stores both the messages sent from the user and the automatic response messages output by the chatbot unit 102. The user interest level calculation unit 104 reads the message history from the message history table 103t. If it encounters an ‘And then?’ message, it assigns an increased degree of relatedness to pairs of words occurring in the preceding and following user messages. After obtaining degrees of relatedness between key words in this way, the user interest level calculation unit 104 calculates degrees of user interest by, for example, equation (4) above.

The automatic response messages of the chatbot unit 102 are stored for the following reasons:

(1) Locating the ‘And then?’ message: The user interest level calculation unit 104 must know when the ‘And then?’ message was output. Therefore, the automatic response messages of the chatbot unit 102 need to be stored.

(2) Locating the preceding message: When an ‘And then?’ message is found, the user interest level calculation unit 104 must obtain the preceding user message. The preceding user message can be found easily if both the messages sent from the user and the automatic response messages of the chatbot unit 102 are stored in sequence.

Words occurring in the same context of a conversation between users can also be presumed to have a high degree of relatedness, but at the present stage, it is difficult to judge the context of a conversation among people. It is very easy, however, to have the chatbot unit 102 output a message like ‘And then?’ intentionally, and to use this message as a marker for finding related key words, as in the fourth embodiment.

The marker phrase output by the chatbot unit 102 is not limited to ‘And then?’ Any phrase that urges the user to continue the conversation can be used. More than one such phrase may be used. The ‘And then?’ message that appears in the fourth embodiment should be regarded as one representative of a large class of automatic response messages that can be used as marker phrases.

The fourth embodiment, by having the chatbot unit 102 output one or more predetermined marker phrases, guides the system users into creating a large collection of related messages from which relations between key words can be inferred automatically. Because a key word relation table such as the one shown in FIG. 9 does not need to be created in the system design or set-up stage, much time and effort can be saved, which reduces the cost of the system.

### Fifth Embodiment

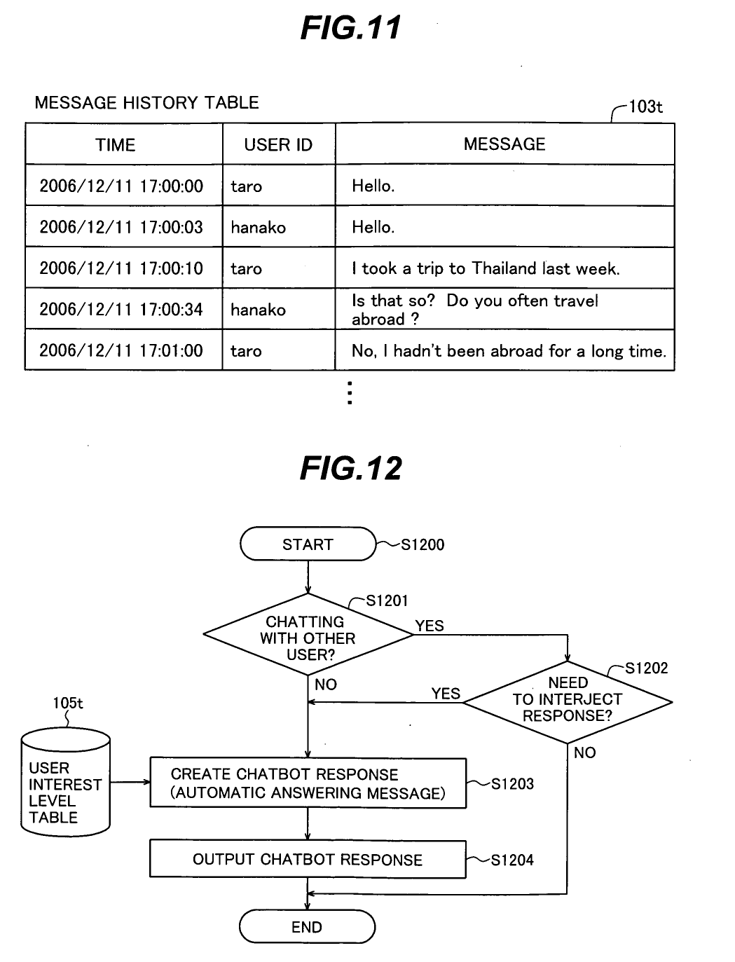

FIG. 11 shows the structure of the message history table 103t according to a fifth embodiment of the invention, and shows exemplary data. The message history table 103t shown in FIG. 11 differs from the table shown in FIG. 2 in the first embodiment in that a ‘Time’ column is added. The ‘Time’ column records the date and time when each message is sent. The other elements are the same as in FIG. 2, so descriptions will be omitted.

When the user interest level calculation unit 104 calculates a user interest level on the basis of messages read from the message history table 103t, the difference between the current time and the value in the ‘Time’ column in FIG. 11 is taken, and newer messages are considered to indicate a higher user interest level. In this case, the level of user interest in a key word can be obtained by the equation (5) below:

$$User interest level = {\sum }_{k = 1}^{n} g ( Δ {t}_{k} ) \qquad ( 5 )$$

where g(Δt) is a monotonically decreasing function, i.e., a function such that if Δt₁>Δt₂, then g(Δt₁)<g(Δt₂), and Δtₖ is time elapsed after the date and time when a key word has appeared in a message.

By giving newer information greater weight than older information, the fifth embodiment keeps up to date with users' changing interests, so that users can be matched according to their current interests. This method can also be used in the second to fourth embodiments.

### Sixth Embodiment

When the user interest level calculation unit 104 calculates user interest levels on the basis of messages read from the message history table 103t, it may give greater weight to more uncommon interests, and less weight to more common interests. The level of user interest in a subject is then obtained from an equation of the following form (6):

User interest level=f(n, mₓ, m_{y}) (6)

where f (n, mₓ, m_{y}) is a function such that
if n₁<n₂ then f(n₁, mₓ, m_{y})<f(n₂, mₓ, m_{y})
if mₓ₁<mₓ₂, then f(n, mₓ₁, m_{y})>f(n, mₓ₂, m_{y}),
if m_{y1}<m_{y2}, then f(n, mₓ, m_{y1})<f(n, mₓ, m_{y2}),

and the symbols have the following meanings:

n: number of times the user under consideration has mentioned the subject

mₓ: number of users that have ever mentioned the subject

m_{y}: total number of users

The equation (6) above discounts words and phrases that characterize general subjects that a high proportion of users have discussed, and gives greater weight to words and phrases characterizing the particular interests of smaller numbers of users. Therefore, users can be matched with other users sharing the same particular interests. This method can also be used in the second to fifth embodiments.

### Seventh Embodiment

In the first to sixth embodiments described above, the chatbot unit 102 communicates with a user only if the user is not already chatting with another user in the chat room. In the seventh embodiment, the chatbot unit 102 may also interject responses into an ongoing chat between users.

FIG. 12 is a flowchart illustrating the operation of the chatbot unit 102 in the seventh embodiment. The steps will be described below.

Steps S1200 and S1201: These steps are the same as steps S700 and S701 in FIG. 7.

Step S1202: The chatbot unit 102 decides whether it should interject an automatic response message into a chat between users. This decision may be made according to any of the following rules:

(1) An automatic response message is necessary if a user message contains a certain key word.

(2) An automatic response message is necessary if a user message has not been sent for a certain period of time or longer.

(3) Automatic response messages are necessary at random times, independent of user messages.

Step S1203: The chatbot unit 102 searches the user interest level table 105t for a subject of interest to the users and generates an interjectable response (an automatic response message) containing a word or phrase related to that subject. The chatbot unit 102 preferably finds a shared interest common to all of the users in the chat room, or to as many of these users as possible, and generates an automatic response message containing a word or phrase related to the shared subject of interest.

Step S1204: The chatbot unit 102 outputs the interjectable response to the chat functional unit 101.

In the seventh embodiment, the chatbot unit 102 can enliven a chat between users by interjecting automatic response messages related to subjects of common interest to the users. Even when users chat with each other for the first time, the chatbot unit 102 can encourage them to talk about subjects of common interest. If users have started chatting without matching, the chatbot unit 102 can help them find a common interest.

Eighth Embodiment

According to an eighth embodiment of the invention, the chatbot unit 102 has an automatic learning function and can output automatic response messages customized for each user.

In the eighth embodiment, the chatbot unit 102 automatically learns from the messages sent by each user and can output imitative response messages similar to the messages sent by the user, mentioning subjects in which the user is interested. The chatbot unit 102 can then act as an avatar of the user by generating messages on behalf of the user. While users are chatting with each other, for example, the chatbot unit 102 can join the conversation, using the message content it has learned, to suggest a change of topic, or to lead the conversation toward a particular user's interests.

Because the chatbot unit 102 can output messages including learned content of interest to a particular user, before chatting with the particular user, another user can communicate with the chatbot unit 102 in order to discover the interests of the particular user.

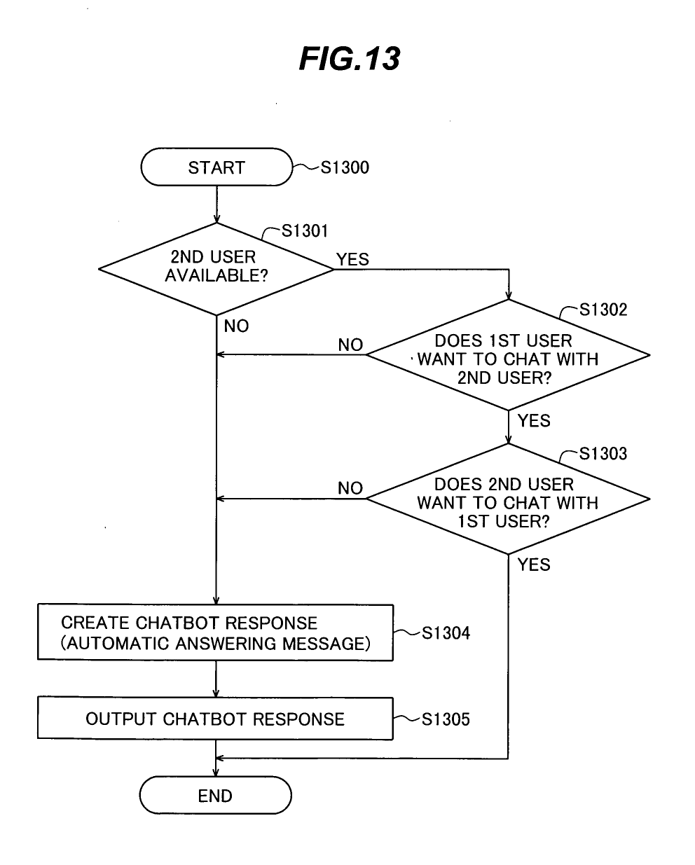

FIG. 13 is a flowchart illustrating the operation of the chatbot unit 102 in the eighth embodiment.

Steps S1300 and S1301: These steps are the same as steps S700 and S701 in FIG. 7.

Step S1302: If a first user is not currently chatting, the chatbot unit 102 decides whether the first user would like to chat with a second user. This decision can be made by, for example, having the user input information beforehand indicating whether or not the user wants to chat. If the first user wants to chat, the processing goes to step S1303. If the first user does not want to chat, the processing goes to step S1304.

Step S1303: The chatbot unit 102 decides whether the second user wants to chat with the first user. This decision can be made in the same way as the decision in step S1302, by having the second user input information beforehand. If the second user wants to chat with the first user, the processing ends. If the second user does not want to chat with the first user, the processing goes to step S1304.

Step S1304: The chatbot unit 102 generates a chatbot response (automatic response message) including content it has learned with its automatic learning function.

Step S1305: The chatbot unit 102 outputs the chatbot response to the chat functional unit 101.

Machine learning is a continuing field of research in artificial intelligence, but for the present embodiment, comparatively simple learning algorithms can be used. For example, the following methods can be used:

(1) A user message taken from the message history table 103t is used as a template, and an automatic response message is generated by modifying the template, e.g., by replacing ‘I’ with ‘you’.

(2) User messages are morphologically analyzed, the results are stored, and the results are used together with a Markov model to generate automatic response messages.

In the eighth embodiment, the chatbot unit 102 has a learning function with which it can automatically be trained to generate response messages reflecting the interests of particular users. A user who is considering chatting with another particular user can decide whether or not to do so by first chatting with the chatbot unit 102, which answers with messages including content learned from the particular user. If two users have familiarized themselves with each other's interests by communicating with the chatbot unit 102, when they start chatting with each other, a suitable topic will already have been provided and they will not be at a loss for words.

Although the first to eighth embodiments have been described on the basis of a system architecture in which messages are exchanged through a user-to-user communication apparatus 100, these embodiments can also be applied to a system architecture in which messages are exchanged directly between users, and between users and a chatbot. Copies of the messages are sent to the user-to-user communication apparatus 100 for storage and analysis. On the basis of its analysis, the user-to-user communication apparatus 100 matches users and presents its matches, after which the users can proceed to communicate with each other from their own terminal equipment.

The first to eighth embodiments have been described in the context of chats, but the invention can be applied to any system and that enables users of user terminals to communicate socially through a network.

Those skilled in the art will recognize that further variations are possible within the scope of the invention, which is defined in the appended claims.

What is claimed is:

1. A method of facilitating exchanges of messages between users using user terminals interconnected by a network to which a computing apparatus is also connected, the computing apparatus including an automatic response unit for generating automatic response messages in response to the messages sent by the users, the method comprising:
storing a message history of the messages sent by the users, including at least messages sent by the users to the automatic response unit, in a message history table in a storage unit in the computing apparatus;
identifying users with similar interests from the message history stored in the message history table, taking the messages sent by the users to the automatic response unit into account; and
presenting information enabling the users identified as having similar interests to exchange further messages with each other.

2. The method of claim 1, wherein identifying users with similar interests further comprises:
extracting each user's interests from the message history stored in the message history table;
calculating each user's interest levels in the extracted interests;
storing information indicating each user's interests and the calculated interest levels in a user interest level table in the storage unit; and
calculating similarities of the users' interest levels in shared interests by using the information stored in the user interest level table.

3. The method of claim 2, wherein:
storing the message history also includes storing the messages sent by the users to other users in the message history table; and
calculating each user's interest levels further includes weighting the messages stored in the message history table, giving greater weight to the messages sent to the automatic response unit than to the messages sent to the other users.

4. The method of claim 2, wherein calculating each user's interest levels further comprises:
counting occurrences of first key words directly related to the user's interests in the messages sent by the user; and
counting occurrences of second key words related to the first key words in the messages sent by the user.

5. The method of claim 4, wherein calculating each user's interest levels further comprises:
storing coefficients indicating degrees of relatedness of the second key words to the first key words in a key word relation table in the storage unit; and
multiplying counts of occurrences of the second key words by said coefficients.

6. The method of claim 4, wherein the automatic response messages generated by the automatic response unit include a nonspecific message urging continuation of an ongoing conversation, and calculating each user's interest levels further comprises:
identifying pairs of messages sent by users before and after receiving the nonspecific message from the automatic response unit; and
identifying relations between the first key words and the second key words from said pairs of messages.

7. The method of claim 2, wherein storing the message history includes storing times of sending of the messages, and calculating each user's interest levels includes weighting the messages stored in the message history table according to their times of sending, greater weights being assigned to more recently sent messages.

8. The method of claim 2, wherein calculating each user's interest levels includes weighting the user's interests according to the number of users with which the interests are shared, greater weight being assigned to interests shared with fewer users.

9. The method of claim 2, further comprising:
searching the user interest level table to find an interest shared by a plurality of users currently exchanging messages;
having the automatic response unit generate an interjectable message related to the interest shared by the plurality of users; and
interjecting the interjectable message into the exchange of messages between the plurality of users.

10. The method of claim 1, further comprising:
training the automatic response unit, from the message history stored in the message history table, to generate imitative messages that imitate the messages sent by a first user among said users by mentioning the first user's interests;
and sending the imitative messages to a second user among said users, thereby enabling the second user to exchange messages with the automatic response unit instead of exchanging messages with the first user.

11. A machine-readable recording medium storing a user-to-user communication program including instructions for causing a computer to carry out the user-to-user communication method of claim 1.

12. An apparatus for facilitating exchanges of messages between users using user terminals, comprising:
a storage unit for storing a message history table;
an automatic response unit for generating automatic response messages in response to the messages sent by the users;
a history keeping unit for storing the messages sent by the users, including at least the messages sent by the users to the automatic response unit, in the message history table;
an identification unit for identifying users having similar interests from the message history stored in the message history table, taking the messages sent by the users to the automatic response unit into account; and
a presentation unit for presenting information enabling the users identified as having similar interests to exchange further messages with each other.

13. The apparatus of claim 12, wherein the storage unit also stores a user interest level table indicating the users' interests and interest levels, the apparatus further comprising:
a user interest level calculation unit for extracting the users' interests from the message history stored in the message history table, calculating the users' interest levels in the extracted interests, and storing information indicating each user's interests and the calculated interest levels in the user interest level table; and
a user interest level similarity calculation unit for calculating similarities of the users' interest levels in shared interests by using the information stored in the user interest level table.

14. The apparatus of claim 13, wherein:
the history keeping unit also stores messages sent by the users to other users in the message history table; and
the user interest level calculation unit, in calculating the users' interest levels, weights the messages stored in the message history table, giving greater weight to the messages sent to the automatic response unit than to the messages sent to the other users.

15. The apparatus of claim 13, wherein the user interest level calculation unit calculates each user's interest levels by counting occurrences of first key words directly related to the user's interests in the messages sent by the user, and counting occurrences of second key words related to the first key words in the messages sent by the user.

16. The apparatus of claim 13, wherein:
the storage unit stores a key word relation table giving coefficients indicating degrees of relatedness of the second key words to the first key words; and
the user interest level calculation unit multiplies counts of occurrences of the second key words by said coefficients.

17. The apparatus of claim 13, wherein:
the automatic response messages generated by the automatic response unit include a nonspecific message urging continuation of an ongoing conversation, and;
the user interest level calculation unit identifies pairs of messages sent by users before and after receiving the nonspecific message from the automatic response unit, and identifies relations between the first key words and the second key words from said pairs of messages.

18. The apparatus of claim 13, wherein the automatic response unit searches the user interest level table to find an interest shared by a plurality of users currently exchanging messages and generates an interjectable message related to the interest shared by the plurality of users, and the apparatus interjects the interjectable message into the exchange of messages between the plurality of users.

19. The apparatus of claim 12, wherein the automatic response unit automatically learns the users' interests from the message history table, learns to generate imitative messages that imitate the messages sent by a first user among said users by mentioning the first user's interests, and sends the imitative messages to a second user among said users, thereby enabling the second user to exchange messages with the automatic response unit instead of exchanging messages with the first user.
